(19) United States
(12) Patent Application Publication
(10) Pub. No.: US 2025/0203397 A1
(43) Pub. Date: Jun. 19, 2025

(54) METHOD AND APPARATUS FOR ADAPTATION OF MEASUREMENT GAP CONFIGURATION WITH DYNAMIC CONTROL SIGNALING

(71) Applicant: MEDIATEK INC., Hsinchu City (TW)

(72) Inventor: Chi-Hsuan HSIEH, Hsinchu City (TW)

(21) Appl. No.: 18/846,888

(22) PCT Filed: Jun. 13, 2023
(86) PCT No.: PCT/CN2023/099800

§ 371 Date: Sep. 13, 2024

Related U.S. Application Data
(60) Provisional application No. 63/368,506, filed on Jul. 15, 2022.
(60) Provisional application No. 63/377,741, filed on Sep. 30, 2022.

(51) Int. Cl. H04W 24/02; H04W 72/231; H04W 80/02

(52) U.S. Cl. CPC H04W 24/02; H04W 72/231; H04W 80/02

(57) ABSTRACT

Various solutions for adaptation of measurement gap configuration with dynamic control signaling are described. A network node may transmit a configuration of one or more measurement gaps (MGs) to a user equipment (UE). The network node may determine a specific type of traffic associated with the UE. The network node may transmit a downlink control information (DCI) or a medium access control-control element (MAC-CE) to the UE. The DCI or the MAC-CE may indicate an adaptation of at least one of the one or more MGs.

### CROSS REFERENCE TO RELATED PATENT APPLICATION(S)

The present disclosure is part of a non-provisional application claiming the priority benefit of U.S. Patent Application No. 63/368,506, filed 15 Jul. 2022, and U.S. Patent Application No. 63/377,741, filed 30 Sep. 2022. The contents of aforementioned applications are herein incorporated by reference in their entirety.

### TECHNICAL FIELD

The present disclosure is generally related to mobile communications and, more particularly, to adaptation of measurement gap configuration with dynamic control signaling.

### BACKGROUND

Unless otherwise indicated herein, approaches described in this section are not prior art to the claims listed below and are not admitted as prior art by inclusion in this section.

Wireless communication technologies have grown exponentially over the years. A Long-Term Evolution (LTE) system offers high peak data rates, low latency, improved system capacity, and low operating cost resulting from simplified network architecture. LTE systems, also known as the 4^{th} Generation (4G) networks, also provide seamless integration to legacy wireless networks, such as Global System for Mobile communications (GSM) networks, Code-Division Multiple Access (CDMA) networks, and Universal Mobile Telecommunication System (UMTS) networks. In LTE systems, an Evolved Universal Terrestrial Radio Access Network (E-UTRAN) generally includes a plurality of evolved Node-Bs (eNodeBs or eNBs) communicating with a plurality of mobile stations (also referred to as user equipment (UEs)). The 3^{rd} Generation Partner Project (3GPP) network normally includes a hybrid of 2G/3G/4G systems. The next generation mobile network (NGMN) board has decided to focus the future NGMN activities on defining the end-to-end requirements for 5^{th} Generation (5G) New Radio (NR) and 6^{th} Generation (6G) systems.

In conventional communication technology, a UE may be configured with a number of measurement gaps for neighbor cell measurement. That is to say, in the measurement gaps, the network may not schedule the UE to transmit or receive data. However, for some real-time application, data service will be affected/interrupted when the UE needs to perform neighbor cell measurement in the configured measurement gaps, and user experience will be bad.

Accordingly, how to maintain service quality and reduce data interruption of the real-time application has become an important issue. Therefore, there is a need to provide proper schemes to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to adaptation of measurement gap configuration with dynamic control signaling.

In one aspect, a method may involve an apparatus (e.g., a network node) transmitting a configuration of one or more measurement gaps (MGs) to a UE. The method may also involve the apparatus determining a specific type of traffic associated with the UE. The method may further involve the apparatus transmitting a downlink control information (DCI) or a medium access control-control element (MAC-CE) to the UE. The DCI or the MAC-CE may indicate an adaptation of at least one of the one or more MGs.

In one aspect, an apparatus (e.g., a network node) may comprise a transceiver which, during operation, wirelessly communicates with a UE. The network node may also comprise a processor communicatively coupled to the transceiver. The processor, during operation, may perform operations comprising transmitting, via the transceiver, a configuration of one or more MGs to the UE. The processor may also perform operations comprising determining a specific type of traffic associated with the UE. The processor may further perform operations comprising transmitting, via the transceiver, a DCI or a MAC-CE to the UE. The DCI or the MAC-CE may indicate an adaptation of at least one of the one or more MGs.

In one aspect, a method may involve an apparatus (e.g., a UE) receiving a configuration of one or more MGs from a network node. The method may also involve the apparatus receiving a DCI or a MAC-CE from the network node. The DCI or the MAC-CE may indicate an adaptation of at least one of the one or more MGs. The method may further involve the apparatus applying the adaptation of the at least one of the one or more MGs.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of measurement gap configuration in accordance with current 5G NR framework.

FIG. 2 is a diagram depicting an example scenario of adaptation of measurement gap configuration under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to adaptation of measurement gap configuration with respect to user equipment (UE) and network node in mobile communications. According to the present disclosure, a number of possible solutions may be implemented separately or jointly. That is, although these possible solutions may be described below separately, two or more of these possible solutions may be implemented in one combination or another.

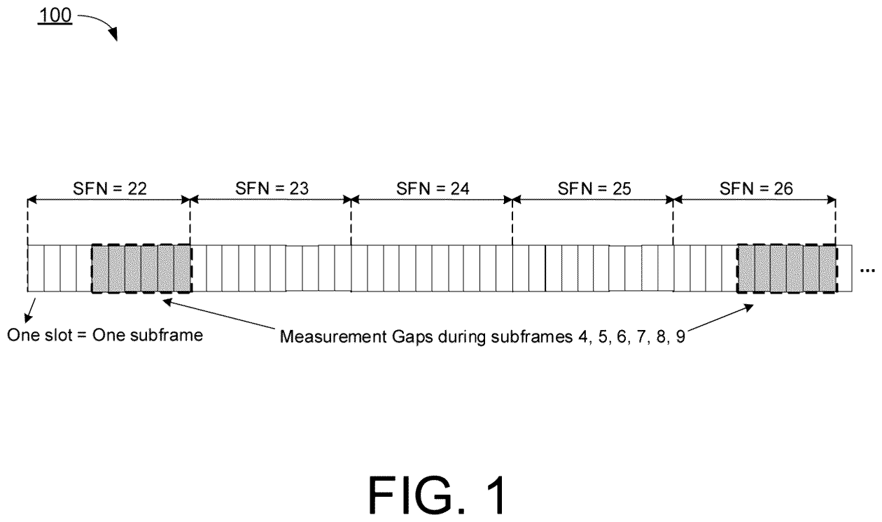

In current 5G NR framework, MGs are configured to allow a UE to perform inter-frequency measurement for radio resource management (RRM) purpose (e.g., mobility management, load balancing, or carrier aggregation (CA) setup). In the configured MGs, the network node may not schedule the UE to transmit/receive data. FIG. 1 illustrates an example scenario 100 of measurement gap configuration in accordance with current 5G NR framework. In scenario 100, the subcarrier spacing (SCS)=15 kilohertz (kHz), and MGs are configured with gapOffset=24, measurement gap length (MGL)=6 milliseconds (ms), and measurement gap repetition period (MGRP)=40 ms. As a result, data scheduling is excluded for 6 ms in every 40 ms. However, for some real-time application (e.g., extended reality (XR), such as virtual reality (VR) and/or augmented reality (AR)), data service will be affected/interrupted due to the configured MGs, and user experience will be bad. Accordingly, how to maintain service quality and reduce data interruption of the real-time application has become an important issue. Therefore, there is a need to provide proper schemes to solve this issue.

In view of the above, the present disclosure proposes a number of schemes pertaining to adaptation of measurement gap configuration with respect to UE and network node in mobile communications. According to some schemes of the present disclosure, a network node is allowed to transmit a downlink control information (DCI) or a medium access control-control element (MAC-CE) to a UE (e.g., which is associated with a specific type of traffic, such as XR traffic) to indicate adaptation of one or more of the configured MGs, such as activating the configured MG(s), deactivating the configured MG(s), skipping the configured MG(s), or changing the setting (e.g., MGL and/or MGRP) of the configured MG(s). Moreover, the UE may report assistance information to the network node, so that the network node may properly determine the adaptation of the configured MG(s) for the specific type of traffic. Furthermore, the network node is allowed to transmit a radio resource control (RRC) signaling, a DCI, or a MAC-CE to the UE to indicate whether the UE performs a transmission/reception operation or not during the deactivated/skipped MG(s). In addition, according to some schemes of the present disclosure, at least one new MGRP, e.g., for the specific type of traffic, is introduced in the measurement gap configuration (e.g., a MeasConfig IE carried in an RRC Reconfiguration message). More specifically, the new MGRP may be defined as an integer multiple of a base repetition period (e.g., 100 ms) that is determined as the common multiple of the periodicity (e.g., 20 ms) of a reference signal (RS) (e.g., synchronization signal block (SSB)) and the reciprocal of the video frame rate (e.g., 60 Hz) associated with the specific type of traffic.

Accordingly, by applying the schemes of the present disclosure, the measurement gap configuration may be adapted in way that the neighbor cell measurement or inter-frequency measurement is relaxed to improve service quality and reduce data interruption of the real-time application.

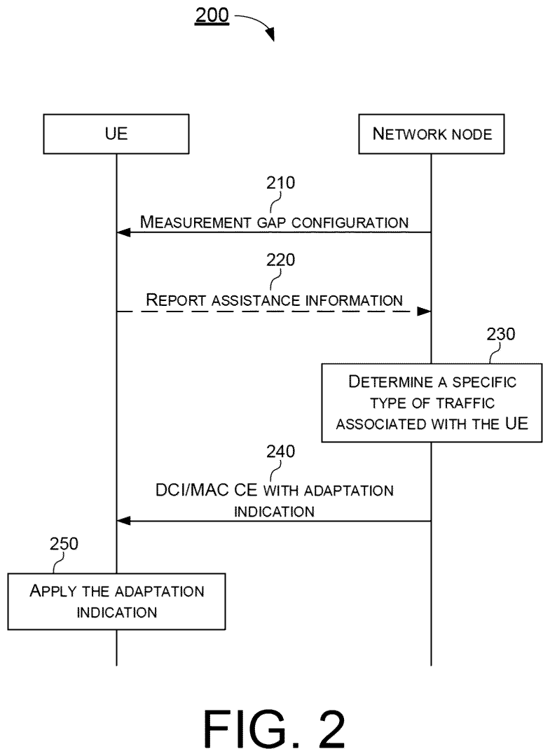

FIG. 2 illustrates an example scenario 200 of adaptation of measurement gap configuration under schemes in accordance with implementations of the present disclosure. Scenario 200 involves a UE and a network node which may be a part of a wireless network (e.g., an LTE network, a 5G NR network, an IoT network, or a 6G network). As shown in FIG. 2, at 210, the network node may transmit a measurement gap configuration to the UE. Specifically, the measurement gap configuration may include the configuration of one or more measurement gaps (MGs), and may be transmitted via RRC signaling, e.g., RRC configuration. Although not shown in FIG. 2, the UE may reply to the network node with a response message to complete the configuration process.

At 220, the UE may report assistance information to the network node, so that the network node may properly determine the dynamic adaptation of the configured MGs for a specific type of traffic (e.g., XR traffic, such as VR and/or AR traffic). The assistance information may be reported via RRC signaling (e.g., in a UE assistance information (UAI) message), or in an uplink (UL) medium access control-control element (MAC-CE), or on physical uplink control channel (PUCCH) or physical uplink shared channel (PUSCH). More specifically, the assistance information may include at least one of the following: (1) information indicating whether the UE is in a condition for MG adaptation; (2) the link condition of the UE; (3) an indication of the XR mode being in use by the UE; and (4) the XR traffic pattern of the UE. The condition for MG adaptation may be determined by a stationary/MG-free criteria. In some implementations, the stationary/MG-free criteria may be the same as the lowMobilityEvaluation or not-at-cell-edge criteria defined in 5G NR Rel-16. In some implementations, the stationary/MG-free criteria may be the same as the stationary or not-at-cell-edge criteria defined in 5G NR Rel-17 (RRM relaxation for reduced-capability (RedCap) UEs). In some implementations, the stationary/MG-free criteria may be based on RSRP/RSRQ/SINR of one or multiple serving cells. It is noteworthy that, 220 is optional depending on whether the network node needs the assistance information for MG adaptation or not.

At 230, the network node may determine a specific type of traffic (e.g., XR traffic) associated with the UE, which would require MG adaptation.

At 240, the network node may transmit a DCI/MAC-CE to the UE. More specifically, the DCI/MAC-CE may indicate an adaptation of at least one of the configured MG(s). The DCI may be a scheduling DCI (e.g., DCI 1_1/0_1), a non-scheduling DCI (e.g., DCI 2_6), or a new DCI specific for MG adaptation. Additionally, if a non-scheduling DCI is used, the UE may need to transmit an acknowledgment (e.g., hybrid automatic repeat request (HARQ) acknowledgment (ACK)) of receipt of the DCI/MAC-CE to the network node. The DCI/MAC-CE may be transmitted on a primary cell (PCell) or a primary secondary cell (PSCell). In some implementations, the adaptation may refer to activating/deactivating the indicated MG(s). In some implementations, the adaptation may refer to skipping the indicated MG(s). In some implementations, the adaptation may refer to changing the setting (e.g., MGL and/or MGRP) of the indicated MG(s).

At 250, the UE may apply the adaptation of the at least one of the configured MG(s), to improve service quality and reduce data interruption of the specific type of traffic.

In some implementations, the DCI/MAC-CE may include a bitmap (e.g., a GapStatus information element (IE)), and each bit of the bitmap may indicate the gap status (e.g., ON or OFF) or the MG setting change for each configured gap ID. In some implementations, the DCI/MAC-CE may include one or several bits to indicate the gap status (e.g., ON or OFF) or the MG setting change for all the configured MGs, or for each frequency range (FR) (e.g., FR1 or FR2), or for one specific gap ID. In some implementations, the DCI/MAC-CE may also indicate a skipping duration for each configured gap ID or for all configured MGs, if the indicated adaptation refers to the case of MG skipping. In some implementations, the adaptation may apply to the cells in the same cell group that the cell where the DCI/MAC-CE is received belongs to. In some implementations, the adaptation may apply to the cells in the same FR that the cell where the DCI/MAC-CE is received operates in, or apply to all cells, or apply to some specific cells.

### Illustrative Implementations

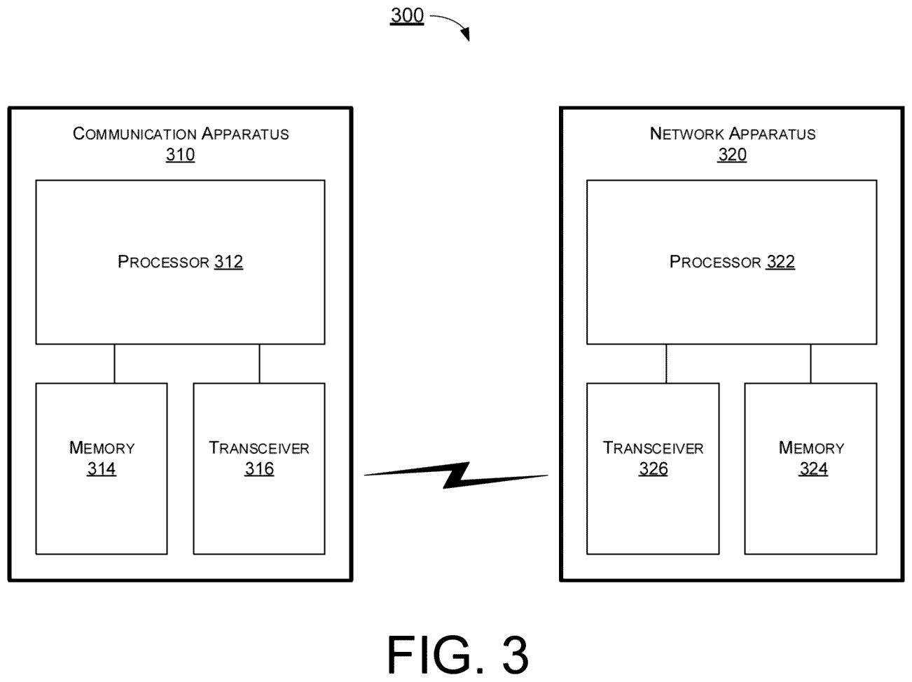

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to adaptation of measurement gap configuration with respect to user equipment and network apparatus in mobile communications, including scenarios/schemes described above as well as processes 400, 500, 600, and 700 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a next generation NodeB (gNB) or a transmission and reception point (TRP) in 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including adaptation of measurement gap configuration in a UE (e.g., as represented by communication apparatus 310) and a network node (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, network apparatus 320 may also include a transceiver 326 coupled to processor 322 and capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 310 and network apparatus 320 may be a communication entity capable of communicating with each other using various proposed schemes in accordance with the present disclosure. For illustrative purposes and without limitation, a description of capabilities of communication apparatus 310, as a UE, and network apparatus 320, as a network node, is provided below.

Under certain proposed schemes in accordance with the present disclosure with respect to adaptation of measurement gap configuration with dynamic control signaling, processor 322 of network apparatus 320, implemented in or as a network node, may transmit, via transceiver 326, a configuration of one or more MGs to communication apparatus 310. Additionally, processor 322 may determine a specific type of traffic (e.g., XR traffic) associated with communication apparatus 310. Moreover, processor 322 may transmit, via transceiver 326, a DCI/MAC-CE to communication apparatus 310. More specifically, the DCI/MAC-CE may indicate an adaptation of at least one of the one or more MGs. Likewise, from the aspect of communication apparatus 310, implemented in or as a UE, processor 312 may receive, via transceiver 316, the configuration of one or more MGs from network apparatus 320, and receive, via transceiver 316, the DCI/MAC-CE from network apparatus 320. Accordingly, processor 312 may apply the adaptation of the at least one of the one or more MGs.

In some implementations, the adaptation of the at least one of the one or more MGs may include one of the following: (1) activating the at least one of the one or more MGs; (2) deactivating the at least one of the one or more MGs; (3) skipping the at least one of the one or more MGs; and (4) changing a setting of the at least one of the one or more MGs.

In some implementations, the setting of the at least one of the one or more MGs may include at least one of a measurement gap repetition period and a measurement gap length.

In some implementations, the DCI, the MAC-CE, or an RRC signaling may indicate whether communication apparatus 310 performs a transmission or reception operation or not during the deactivated or skipped one or more MGs.

In some implementations, the DCI may include a scheduling DCI, a non-scheduling DCI, or a DCI specific for MG adaptation.

In some implementations, the DCI/MAC-CE may be transmitted on a PCell or PSCell.

In some implementations, processor 322 may also receive, via transceiver 326, assistance information from communication apparatus 310. More specifically, the assistance information may include at least one of the following: (1) information indicating whether communication apparatus 310 is in a condition for MG adaptation; (2) a link condition of communication apparatus 310; (3) an indication of an XR mode being in use by communication apparatus 310; and (4) an XR traffic pattern of communication apparatus 310. Additionally, processor 322 may also determine the adaptation of the at least one of the one or more MGs according to the assistance information.

Under certain proposed schemes in accordance with the present disclosure with respect to adaptation of measurement gap configuration with new MGRP, processor 322 of network apparatus 320, implemented in or as a network node, may determine a traffic type. Additionally, processor 322 may determine an MGRP for the traffic type according to a periodicity of an RS and a video frame rate associated with the traffic type. Moreover, processor 322 may transmit, via transceiver 326, a measurement gap configuration with the MGRP to communication apparatus 310. Likewise, from the aspect of communication apparatus 310, implemented in or as a UE, processor 312 may receive, via transceiver 316, the measurement gap configuration with the MGRP for the traffic type from network apparatus 320, and accordingly, apply the MGRP for the traffic type.

In some implementations, the RS may include an SSB.

In some implementations, determining the measurement gap repetition period may include: determining a base repetition period according to a common multiple of the periodicity of the SSB and a reciprocal of the video frame rate; and determining the measurement gap repetition period according an integer multiple of the base repetition period.

In some implementations, the measurement gap repetition period may be 100 milliseconds in a case that the periodicity of the SSB is 20 milliseconds and the video frame rate is 60 hertz (Hz).

In some implementations, the traffic type may indicate an XR traffic.

### Illustrative Processes

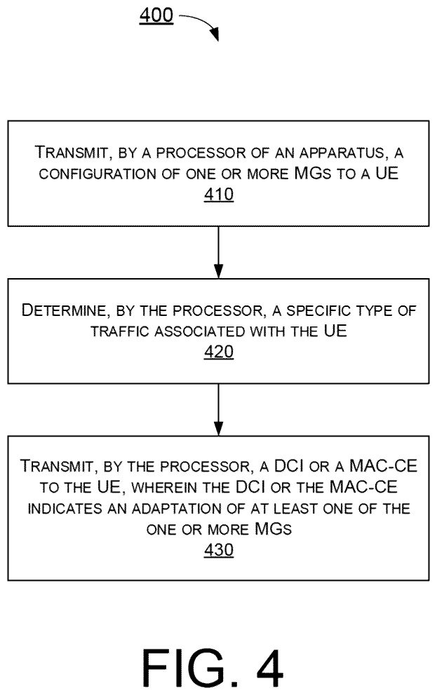

FIG. 4 illustrates an example process 400 in accordance with an implementation of the present disclosure. Process 400 may be an example implementation of above scenarios/schemes, whether partially or completely, with respect to adaptation of measurement gap configuration with dynamic control signaling. Process 400 may represent an aspect of implementation of features of network apparatus 320. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by network apparatus 320 or any base stations or network nodes. Solely for illustrative purposes and without limitation, process 400 is described below in the context of network apparatus 320. Process 400 may begin at block 410.

At 410, process 400 may involve processor 322 of network apparatus 320 transmitting, via transceiver 326, a configuration of one or more MGs to a UE. Process 400 may proceed from 410 to 420.

At 420, process 400 may involve processor 322 determining a specific type of traffic associated with the UE. Process 400 may proceed from 420 to 430.

At 430, process 400 may involve processor 322 transmitting, via transceiver 326, a DCI/MAC-CE to the UE. More specifically, the DCI/MAC-CE may indicate an adaptation of at least one of the one or more MGs.

In some implementations, the adaptation of the at least one of the one or more MGs may include one of the following: (1) activating the at least one of the one or more MGs; (2) deactivating the at least one of the one or more MGs; (3) skipping the at least one of the one or more MGs; and (4) changing a setting of the at least one of the one or more MGs.

In some implementations, the setting of the at least one of the one or more MGs may include at least one of a measurement gap repetition period and a measurement gap length.

In some implementations, the DCI, the MAC-CE, or an RRC signaling may indicate whether the UE performs a transmission or reception operation or not during the deactivated or skipped one or more MGs.

In some implementations, the DCI may include a scheduling DCI, a non-scheduling DCI, or a DCI specific for MG adaptation.

In some implementations, the DCI/MAC-CE may be transmitted on a PCell or PSCell.

In some implementations, process 400 may further involve processor 322 receiving, via transceiver 326, assistance information from the UE. More specifically, the assistance information may include at least one of the following: (1) information indicating whether the UE is in a condition for MG adaptation; (2) a link condition of the UE; (3) an indication of an XR mode being in use by the UE; and (4) an XR traffic pattern of the UE. Additionally, process 400 may further involve processor 322 determining the adaptation of the at least one of the one or more MGs according to the assistance information.

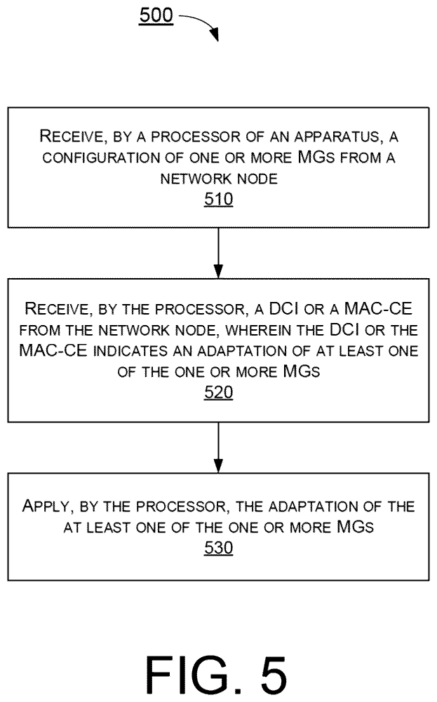

FIG. 5 illustrates an example process 500 in accordance with an implementation of the present disclosure. Process 500 may be an example implementation of above scenarios/schemes, whether partially or completely, with respect to adaptation of measurement gap configuration with dynamic control signaling. Process 500 may represent an aspect of implementation of features of communication apparatus 310. Process 500 may include one or more operations, actions, or functions as illustrated by one or more of blocks 510, 520, and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of communication apparatus 310 receiving, via transceiver 316, a configuration of one or more MGs from a network node. Process 500 may proceed from 510 to 520.

At 520, process 500 may involve processor 312 receiving, via transceiver 316, a DCI/MAC-CE from the network node. More specifically, the DCI/MAC-CE may indicate an adaptation of at least one of the one or more MGs. Process 500 may proceed from 520 to 530.

At 530, process 500 may involve processor 312 applying the adaptation of the at least one of the one or more MGs.

In some implementations, the adaptation of the at least one of the one or more MGs may include one of the following: (1) activating the at least one of the one or more MGs; (2) deactivating the at least one of the one or more MGs; (3) skipping the at least one of the one or more MGs; and (4) changing a setting of the at least one of the one or more MGs.

In some implementations, the setting of the at least one of the one or more MGs may include at least one of a measurement gap repetition period and a measurement gap length.

In some implementations, the DCI, the MAC-CE, or an RRC signaling may indicate whether communication apparatus 310 performs a transmission or reception operation or not during the deactivated or skipped one or more MGs.

In some implementations, the DCI may include a scheduling DCI, a non-scheduling DCI, or a DCI specific for MG adaptation.

In some implementations, the DCI/MAC-CE may be transmitted on a PCell or PSCell.

In some implementations, process 500 may further involve processor 312 reporting, via transceiver 316, assistance information to the network node. More specifically, the assistance information may include at least one of the following: (1) information indicating whether communication apparatus 310 is in a condition for MG adaptation; (2) a link condition of communication apparatus 310; (3) an indication of an XR mode being in use by communication apparatus 310; and (4) an XR traffic pattern of communication apparatus 310. Additionally, the adaptation of the at least one of the one or more MGs may be determined according to the assistance information.

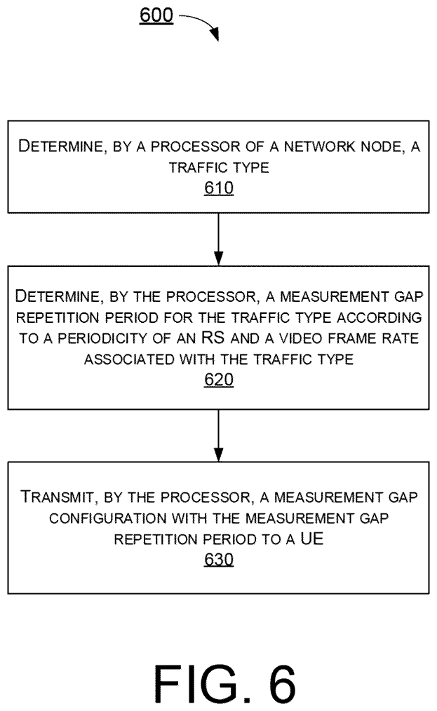

FIG. 6 illustrates an example process 600 in accordance with an implementation of the present disclosure. Process 600 may be an example implementation of above scenarios/schemes, whether partially or completely, with respect to adaptation of measurement gap configuration with new MGRP. Process 600 may represent an aspect of implementation of features of network apparatus 320. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 320 or any base stations or network nodes. Solely for illustrative purposes and without limitation, process 600 is described below in the context of network apparatus 320. Process 600 may begin at block 610.

At 610, process 600 may involve processor 322 of network apparatus 320 determining a traffic type. Process 600 may proceed from 610 to 620.

At 620, process 600 may involve processor 322 determining a measurement gap repetition period for the traffic type according to a periodicity of an RS and a video frame rate associated with the traffic type. Process 600 may proceed from 620 to 630.

At 630, process 600 may involve processor 322 transmitting, via transceiver 326, a measurement gap configuration with the measurement gap repetition period to a UE.

In some implementations, the RS may include an SSB.

In some implementations, determining the measurement gap repetition period may include: determining a base repetition period according to a common multiple of the periodicity of the SSB and a reciprocal of the video frame rate; and determining the measurement gap repetition period according an integer multiple of the base repetition period.

In some implementations, the measurement gap repetition period may be 100 milliseconds in a case that the periodicity of the SSB is 20 milliseconds and the video frame rate is 60 Hz.

In some implementations, the traffic type may indicate an XR traffic.

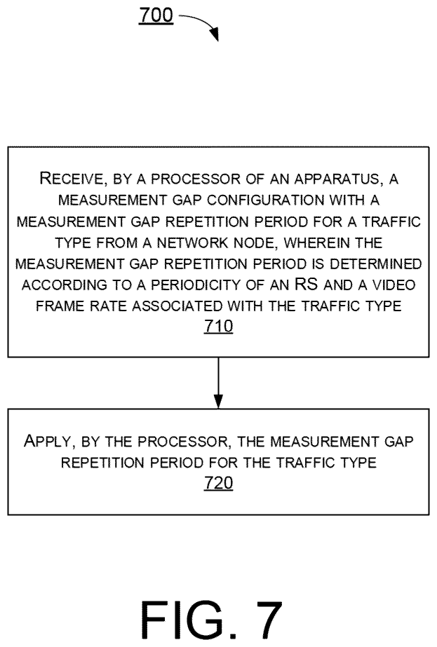

FIG. 7 illustrates an example process 700 in accordance with an implementation of the present disclosure. Process 700 may be an example implementation of above scenarios/schemes, whether partially or completely, with respect to adaptation of measurement gap configuration with new MGRP. Process 700 may represent an aspect of implementation of features of communication apparatus 310. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 310 or any suitable UE or machine type devices. Solely for illustrative purposes and without limitation, process 700 is described below in the context of communication apparatus 310. Process 700 may begin at block 710.

At 710, process 700 may involve processor 312 of communication apparatus 310 receiving, via transceiver 316, a measurement gap configuration with a measurement gap repetition period for a traffic type from a network node. More specifically, the measurement gap repetition period may be determined according to a periodicity of an RS and a video frame rate associated with the traffic type. Process 700 may proceed from 710 to 720.

At 720, process 700 may involve processor 312 applying the measurement gap repetition period for the traffic type.

In some implementations, the RS may include an SSB.

In some implementations, the measurement gap repetition period may be determined according an integer multiple of a base repetition period, and the base repetition period may be determined according to a common multiple of the periodicity of the SSB and a reciprocal of the video frame rate.

In some implementations, the measurement gap repetition period may be 100 milliseconds in a case that the periodicity of the SSB is 20 milliseconds and the video frame rate is 60 Hz.

In some implementations, the traffic type may indicate an XR traffic.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a configuration of one or more measurement gaps (MGs) to a user equipment (UE);
determining, by the processor, a specific type of traffic associated with the UE; and
transmitting, by the processor, a downlink control information (DCI) or a medium access control-control element (MAC-CE) to the UE, wherein the DCI or the MAC-CE indicates an adaptation of at least one of the one or more MGs.

2. The method of claim 1, wherein the adaptation of the at least one of the one or more MGs comprises one of the following:
activating the at least one of the one or more MGs;
deactivating the at least one of the one or more MGs;
skipping the at least one of the one or more MGs; and
changing a setting of the at least one of the one or more MGs.

3. The method of claim 2, wherein the setting comprises at least one of the following:
a measurement gap repetition period; and
a measurement gap length.

4. The method of claim 2, wherein the DCI, the MAC-CE, or a radio resource control (RRC) signaling indicates whether the UE performs a transmission or reception operation or not during the deactivated or skipped one or more MGs.

5. The method of claim 1, wherein the DCI comprises a scheduling DCI, a non-scheduling DCI, or a DCI specific for MG adaptation.

6. The method of claim 1, wherein the DCI or the MAC-CE is transmitted on a primary cell (PCell) or a primary secondary cell (PSCell).

7. The method of claim 1, further comprising:
receiving, by the processor, assistance information from the UE, wherein the assistance information comprises at least one of the following:
information indicating whether the UE is in a condition for MG adaptation;
a link condition of the UE;
an indication of an extended reality (XR) mode being in use by the UE; and
an XR traffic pattern of the UE; and
determining, by the processor, the adaptation of the at least one of the one or more MGs according to the assistance information.

8. An apparatus, comprising:
a transceiver which, during operation, wirelessly communicates with a user equipment (UE); and
a processor communicatively coupled to the transceiver such that, during operation, the processor performs operations comprising:
transmitting, via the transceiver, a configuration of one or more measurement gaps (MGs) to the UE;
determining a specific type of traffic associated with the UE; and
transmitting, via the transceiver, a downlink control information (DCI) or a medium access control-control element (MAC-CE) to the UE, wherein the DCI or the MAC-CE indicates an adaptation of at least one of the one or more MGs.

9. The apparatus of claim 8, wherein the adaptation of the at least one of the one or more MGs comprises one of the following:
activating the at least one of the one or more MGs;
deactivating the at least one of the one or more MGs;
skipping the at least one of the one or more MGs; and
changing a setting of the at least one of the one or more MGs.

10. The apparatus of claim 9, wherein the setting comprises at least one of the following:
a measurement gap repetition period; and
a measurement gap length.

11. The apparatus of claim 9, wherein the DCI, the MAC-CE, or a radio resource control (RRC) signaling indicates whether the UE performs a transmission or reception operation or not during the deactivated or skipped one or more MGs.

12. The apparatus of claim 8, wherein the DCI comprises a scheduling DCI, a non-scheduling DCI, or a DCI specific for MG adaptation.

13. The apparatus of claim 8, wherein the DCI or the MAC-CE is received on a primary cell (PCell) or a primary secondary cell (PSCell).

14. The apparatus of claim 8, wherein, during operation, the processor further performs operations comprising:
receiving, via the transceiver, assistance information from the UE, wherein the assistance information comprises at least one of the following:
information indicating whether the apparatus is in a condition for MG adaptation;
a link condition of the apparatus;
an indication of an extended reality (XR) mode being in use by the apparatus; and
an XR traffic pattern of the apparatus; and
determining the adaptation of the at least one of the one or more MGs according to the assistance information.

15. A method, comprising:
receiving, by a processor of an apparatus, a configuration of one or more measurement gaps (MGs) from a network node;
receiving, by the processor, a downlink control information (DCI) or a medium access control-control element (MAC-CE) from the network node, wherein the DCI or the MAC-CE indicates an adaptation of at least one of the one or more MGs; and
applying, by the processor, the adaptation of the at least one of the one or more MGs.

16. The method of claim 15, wherein the adaptation of the at least one of the one or more MGs comprises one of the following:
activating the at least one of the one or more MGs;
deactivating the at least one of the one or more MGs;
skipping the at least one of the one or more MGs; and
changing a setting of the at least one of the one or more MGs.

17. The method of claim 16, wherein the setting comprises at least one of the following:
a measurement gap repetition period; and
a measurement gap length.

18. The method of claim 16, wherein the DCI, the MAC-CE, or a radio resource control (RRC) signaling indicates whether the apparatus performs a transmission or reception operation or not during the deactivated or skipped one or more MGs.

19. The method of claim 15, wherein:
the DCI comprises a scheduling DCI, a non-scheduling DCI, or a DCI specific for MG adaptation; or
the DCI or the MAC-CE is received on a primary cell (PCell) or a primary secondary cell (PSCell).

15. e method of claim 15, further comprising:
reporting, by the processor, assistance information to the network node, wherein the assistance information comprises at least one of the following:
information indicating whether the apparatus is in a condition for MG adaptation;
a link condition of the apparatus;
an indication of an extended reality (XR) mode being in use by the apparatus; and
an XR traffic pattern of the apparatus; and
wherein the adaptation of the at least one of the one or more MGs is determined according to the assistance information.
